(19) United States
(12) Patent Application Publication
(10) Pub. No.: US 2021/0219031 A1
(43) Pub. Date: Jul. 15, 2021

(54) OPTICAL CROSS-CONNECT DEVICE

(71) Applicant: Nippon Telegraph and Telephone Corporation, Tokyo (JP)

(72) Inventors: Hiroki KAWAHARA, Tokyo (JP); Hiroshi YAMAMOTO, Tokyo (JP); Katsuhiro ARAYA, Tokyo (JP); Yoshihiko UEMATSU, Tokyo (JP); Toshiyuki OKA, Tokyo (JP)

(21) Appl. No.: 17/058,416

(22) PCT Filed: May 23, 2019
(86) PCT No.: PCT/JP2019/020498

§ 371 Date: Nov. 24, 2020

(30) Foreign Application Priority Data
May 29, 2018 (JP) 2018-102078

(51) Int. Cl. H04Q 11/00; H04J 14/02

(52) U.S. Cl. CPC H04Q 11/0005; H04Q 2011/0016; H04Q 2011/0058; H04J 14/0212

(57) ABSTRACT

[Problem] To improve the add/drop rates while suppressing the apparatus scale of the ROADM.

[Solution] ROADM includes a wavelength cross-connect portion connected to a plurality of degrees, and a transponder accommodation function portion configured to relay an optical signal of the wavelength cross-connect portion to a transponder, in which the transponder accommodation function portion is configured such that a plurality of elements E that are a plurality of wavelength selective switches including one input port receiving an optical signal from a direction of the wavelength cross-connect portion and a plurality of output ports transmitting an optical signal in a direction toward the transponder is cascade-connected in a plurality of stages, and a plurality of elements E positioned at the same stage of the plurality of stages of cascade connection, to which an optical signal is propagated from the same degree of the plurality of degrees of the wavelength cross-connect portion, are multiple-connected as one module.

### TECHNICAL FIELD

The present disclosure relates to an optical cross-connect apparatus.

### BACKGROUND ART

Wavelength Division Multiplexing (WDM) communication is used to increase the capacity of an optical communication network. A Reconfigurable Optical Add/Drop Multiplexing (ROADM) is used as a multiplexing apparatus that branches/inserts an optical signal corresponding to the WDM. A large number of Wavelength Selective Switches (WSSs) that handles optical signals without converting the optical signal into an electrical signal, are accommodated in this ROADM.

The ROADM is configured such that a wavelength cross-connect portion that connects each line (referred to as a degree) of the optical communication network to communicate with another ROADM, and a transponder accommodation function portion that accommodates a transponder such as a transmitter or a receiver accommodated by the ROADM are connected within the apparatus. The transponder accommodation function portion has a function of connecting a desired wavelength to a desired transponder with respect to a WDM signal from many degrees input/output to/from a wavelength cross-connect portion.

Here, the functions of Colorless, Directionless, and Contentionless (CDC) that enhance the functionality of the transponder accommodation function portion have been noted (Non Patent Literature 1).

With the Colorless function, the wavelength input/output to/from the port is not a fixed wavelength, and the wavelength of the transponder can be changed without physically changing connection.

The Directionless function can expand the input/output degree of the port to be freely set from a fixed direction.

With the Contentionless function, the optical signal of the same wavelength assigned to another degree can be communicated without collision within the apparatus.

In this way, the CDC function capable of flexibly changing the port setting is an advantageous function in that the operability can be improved because the port can be remotely set and the reliability can be economically secured (Non Patent Literature 2).

On the other hand, as the performance index of the ROADM, the larger the number of transponders that add (signal input) to the optical communication network and the number of transponders that drop (signal output) from the optical communication network, the higher the capacity and the better the repeater apparatus. That is, when traffic increases steadily in the future, the number of optical paths that are added/dropped at the ROADM will increase, so it is necessary to improve add/drop rates.

That is, to improve the add/drop rates, it is necessary to increase the number of connection ports of the transponder accommodation function portion. For example, when the add/drop rates are 100%, the ports for the number of wavelengths x the number of degrees are required.

Since a coupler is unsuitable from the viewpoint of signal transmission loss, many WSSs are required to increase the number of connection ports of the transponder accommodation function portion. By accommodating a large number of WSSs in one ROADM, the apparatus scale becomes large, and the size, power, and cost increase.

Non Patent Literature 3 proposes a multiple WSS in which a plurality of WSSs are integrated into one module.

### CITATION LIST

### Non Patent Literature

Non Patent Literature 1: S. Gringeri et al., “Flexible architectures for optical transport nodes and networks”, IEEE Comm., Mag., vol. 48, issue. 7, 2010.

Non Patent Literature 2: Q. Zhang, et al., “Shared Mesh Restoration for OTN/WDM Networks Using CDC-ROADMs”, ECOC2012, Tu4.D.4

Non Patent Literature 3: K. Suzuki, et al., “Application of waveguide/free-space optics hybrid to ROADM device”, JLT, vol35, issue 4, 2017

### SUMMARY OF THE INVENTION

### Technical Problem

To increase the number of transponder connection ports of the ROADM in related art, a configuration in which a large number of WSS modules are used to branch the degree in the apparatus results in a large apparatus scale.

Accordingly, the main object of the present disclosure is to improve the add/drop rates while suppressing the apparatus scale of the ROADM.

### Means for Solving the Problem

To solve the above problems, the optical cross-connect apparatus of the present disclosure has the following features.

The present disclosure includes a wavelength cross-connect portion connected to a plurality of degrees, and a transponder accommodation function portion configured to relay an optical signal of the wavelength cross-connect portion to a transponder, in which the transponder accommodation function portion is configured such that a plurality of wavelength selective switches including one input port receiving an optical signal from a direction of the wavelength cross-connect portion and a plurality of output ports transmitting an optical signal in a direction toward the transponder is cascade-connected in a plurality of stages, and a plurality of the wavelength selective switches positioned at the same stage of the plurality of stages of cascade connection, to which an optical signal is propagated from the same degree of the plurality of degrees of the wavelength cross-connect portion, are multiple-connected as one module.

Accordingly, a plurality of WSS modules on a drop side can be aggregated into one module according to the stage number of a cascade. Accordingly, the drop rate can be improved while suppressing the apparatus scale of the ROADM.

The present disclosure includes a wavelength cross-connect portion connected to a plurality of degrees, and a transponder accommodation function portion configured to relay an optical signal of the wavelength cross-connect portion to a transponder, in which the transponder accommodation function portion is configured such that a plurality of wavelength selective switches including one input port receiving an optical signal from a direction of the wavelength cross-connect portion and a plurality of output ports transmitting an optical signal in a direction toward the transponder is cascade-connected in a plurality of stages, and a plurality of the wavelength selective switches to which an optical signal is propagated from the same degree of the plurality of degrees and the same output port of the wavelength cross-connect portion, are multiple-connected as one module.

Accordingly, a plurality of WSS modules on a drop side can be aggregated into one module regardless of the stage number of a cascade. Accordingly, the drop rate can be improved while suppressing the apparatus scale of the ROADM.

The present disclosure includes a wavelength cross-connect portion connected to a plurality of degrees, and a transponder accommodation function portion configured to relay an optical signal of the wavelength cross-connect portion to a transponder, in which the transponder accommodation function portion is configured such that a plurality of wavelength selective switches including one output port transmitting an optical signal to a direction of the wavelength cross-connect portion and a plurality of input ports receiving an optical signal from a direction of the transponder is cascade-connected in a plurality of stages, and a plurality of the wavelength selective switches positioned at the same stage of the plurality of stages of cascade connection, which propagate an optical signal to the same degree of the plurality of degrees of the wavelength cross-connect portion, are multiple-connected as one module.

Accordingly, a plurality of WSS modules on an add side can be aggregated into one module according to the stage number of a cascade. Accordingly, the add rate can be improved while suppressing the apparatus scale of the ROADM.

The present disclosure includes a wavelength cross-connect portion connected to a plurality of degrees, and a transponder accommodation function portion configured to relay an optical signal of the wavelength cross-connect portion to a transponder, in which the transponder accommodation function portion is configured such that a plurality of wavelength selective switches including one output port transmitting an optical signal to a direction of the wavelength cross-connect portion and a plurality of input ports receiving an optical signal from a direction of the transponder is cascade-connected in a plurality of stages, and a plurality of the wavelength selective switches which propagate an optical signal to the same degree of the plurality of degrees and the same input port of the wavelength cross-connect portion, are multiple-connected as one module.

Accordingly, a plurality of WSS modules on an add side can be aggregated into one module regardless of the stage number of a cascade. Accordingly, the add rate can be improved while suppressing the apparatus scale of the ROADM.

### Effects of the Invention

According to the present disclosure, the add/drop rates can be improved while suppressing the apparatus scale of the ROADM.

### BRIEF DESCRIPTION OF DRAWINGS

FIG. 1 is a configuration view of a ROADM of a comparative example.

FIG. 2 is a plan view of the ROADM of FIG. 1 viewed from an XY plane.

FIG. 3 is a plan view of the ROADM of FIG. 1 viewed from a YZ plane.

FIG. 4 is an explanatory view illustrating principle of a multiple WSS according to the present embodiment.

FIG. 5 is a first example in which the principle of the multiple WSS of FIG. 4 is applied to the ROADM of FIG. 2 according to the present embodiment.

FIG. 6 is a second example in which the principle of the multiple WSS of FIG. 4 is applied to the ROADM of FIG. 2 according to the present embodiment.

### DESCRIPTION OF EMBODIMENTS

An embodiment of the present disclosure will be described below with reference to the drawings.

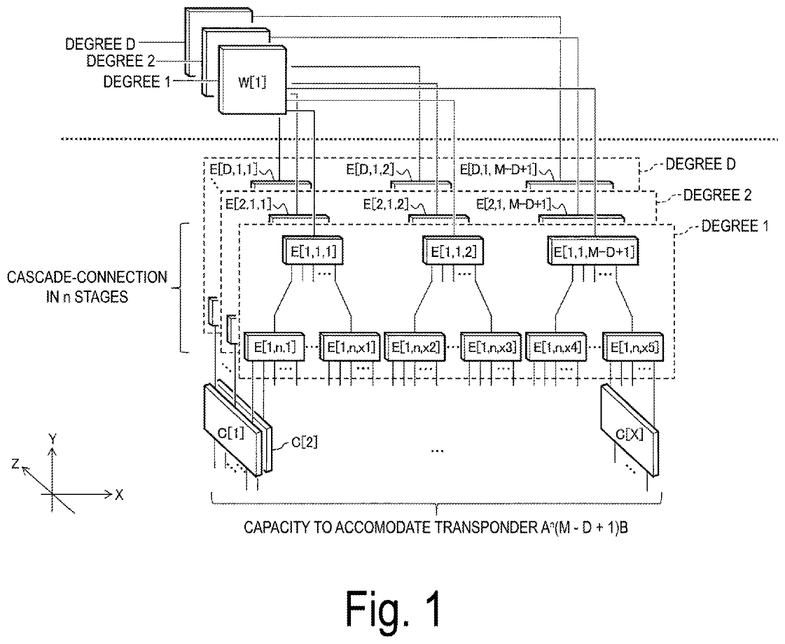

FIG. 1 is a configuration view of a ROADM (optical cross-connect apparatus) of a comparative example. In FIG. 1, the drop side of the ROADM is illustrated, but the add side also has the same configuration except that a signal direction is reversed.

In the ROADM, the following three types of modules are disposed in order from the top. Here, the horizontal broken line in FIG. 1 is a boundary line indicating that the upper side of the horizontal broken line is a wavelength cross-connect portion and the lower side of the horizontal broken line is a transponder accommodation function portion.

(1) A group of wavelength selective switches “1×M WSS” of the wavelength cross-connect portion, indicated by W[1] to W[D] on the upper side of FIG. 1. “1×M WSS” means a 1-input, M-output WSS module. D is the number of degrees accommodated by the ROADM.

(2) A group of wavelength selective switches “1×A WSS” of the transponder accommodation function portion of E[1, 1, 1] to E[1, n, x5] on the center side of FIG. 1.

(3) A group of the wavelength selective switches “D×B CPL” of the transponder accommodation function portion of C[1] to C[X] on the lower side of FIG. 1.

The group (1) of the ROADM will be described. “1×M WSS” having the following three types of ports is provided as modules W[1] to W[D] with the number of degrees, D on the drop side of the wavelength cross-connect portion.

(1a) one input port that receives an input from its own degree (one output port on the add side, on the contrary).

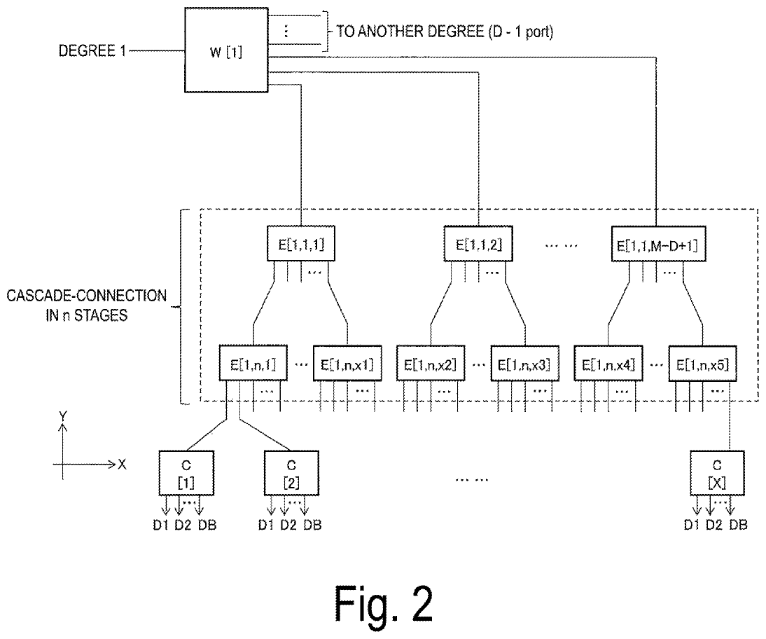

(1b) D−1 output ports for internally connecting to the “1×M WSS” of the drop side of each of other degrees 2 to D (see FIG. 2 when the ROADM of FIG. 1 is viewed from the XY plane).

(1c) M−D+1 output ports for internally connecting to each “1×A WSS” of the transponder accommodation function portion.

The group (2) of the ROADM will be described. In the transponder accommodation function portion, when the “1×A WSS” is one element (E: Element), those elements are cascade-connected in n stages. The element E of the group (2) includes one input port that receives an optical signal from the direction of the wavelength cross-connect portion and a plurality of output ports that transmits the optical signal in the direction toward each transponder. (On the add side, conversely, the element E has a plurality of input ports and one output port)

A set of cascade-connected elements in the first stage to the n-th stage is grouped separately (in the figure, a dotted rectangle) for each of the degrees 1 to D.

To make the positional relationship of each element E easy to understand, an ID is added to the element E with three indices E[i, j, k]. For example, E[D, 1, 2] indicates E=Element, D=D-th degree, 1=first stage cascade, 2=second in the accommodation number.

The first stage of the cascade is positioned at the boundary with the wavelength cross-connect portion. The M−D+1 output ports (1c) from the “1×M WSS” of the wavelength cross-connect portion connect to the input ports of the elements E[1, 1, 1], E[1, 1, 2], . . . E[1, 1, M−D+1], respectively.

The second stage of the cascade is a group of elements that receives the output ports of the first stage elements of the cascade and transfers to the input port of the third stage element of the cascade. For example, E[1, 2, 1] receives an input from the first output port of E[1, 1, 1], and outputs to E[1, 3, 1] to E[1, 3, A], respectively.

The n-th stage (final stage) of the cascade is positioned at the boundary with the group (3) of the “D×B CPL” of C[1] to C[X] positioned further below.

The group (3) of the ROADM will be described. The transponder accommodation function portion is provided with the “D×B CPL”s having output ports connected to the transponders as modules C[1] to C[X]. Here, the “D×B CPL”, that is, a CPL (Coupler) of D inputs and B outputs is used, but a Wavelength Selective Switch (WSS) of D inputs and B outputs may be used, or when the ROADM has a CDC function, a Multicast Switch (MCS) of D inputs and B outputs may be used.

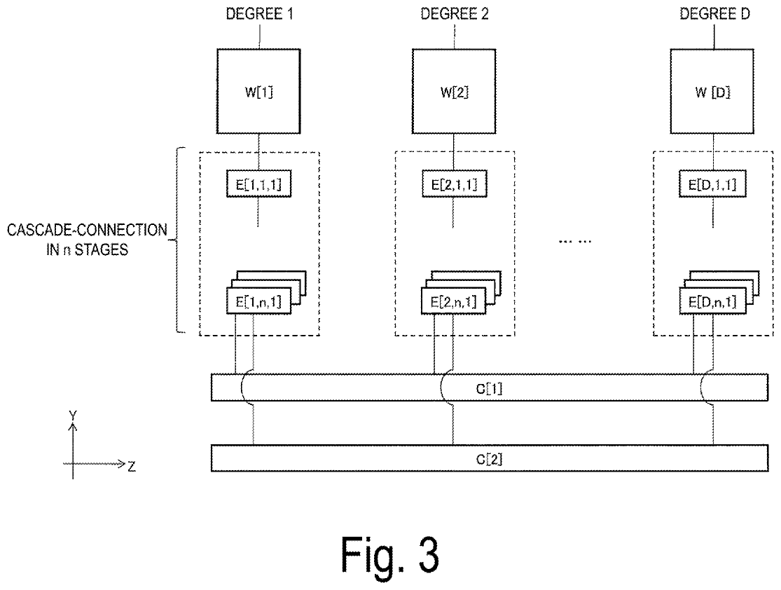

C[1] receives inputs from a total D of the elements E[1, n, 1] to E[D, n, 1] (see FIG. 3 when the ROADM of FIG. 1 is viewed from the YZ plane) and outputs signals to the transponder at B output ports (see FIG. 2).

The C[2] also receives inputs from a total D of the elements E[1, n, 2] to E[D, n, 2], and outputs signals to the transponder at B output ports.

The C[X] also receives inputs from a total D of the elements E[1, n, X] to E[D, n, X], and outputs signals to the transponder at B output ports.

The transponder (not illustrated) connected to each of the C[1] to C[X] is configured as a drop destination receiver or an add source transmitter.

The number of accommodated transponders in one ROADM as a whole is calculated as follows.

The number of accommodated transponders=(the number of C[n]s =X)×(the number of output ports per C[n], B)

(the number of C[n]s, X)=(the total number of the elements E in the n-th stage of cascade)×(the number of output ports per element E, A)

(the total number of elements E in the n-th stage of the cascade)=A to the power of (n−1)×(M−D+1)

Accordingly, the number of accommodated transponders=A to the n-th power×(M−D+1)×B.

The configuration of the ROADM of the comparative example has been described above with reference to FIGS. 1 to 1. In the ROADM of the comparative example, in particular, the element E of the “1×A WSS” of the group (2) is cascade-connected inn stages, and thus when the stage number of the cascade increases, the number of modules for each element E also rapidly increases.

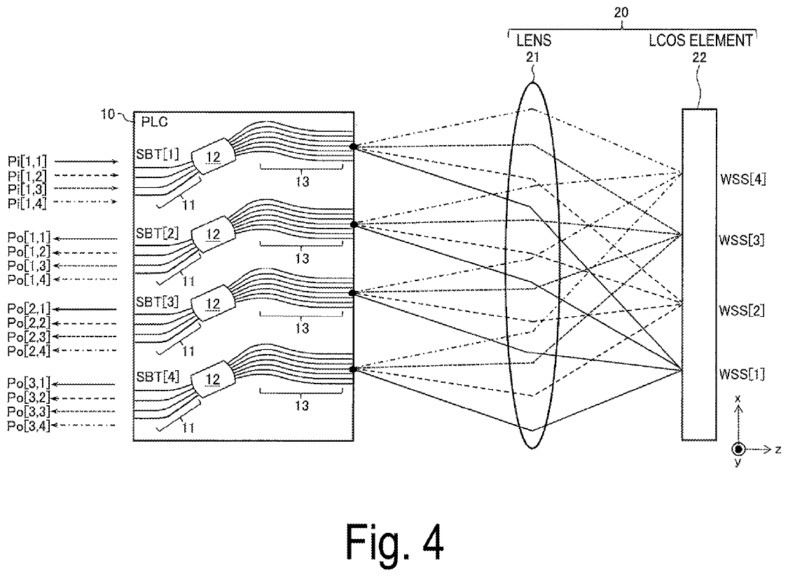

In the present embodiment described with reference to FIGS. 4 to 6, a method of aggregating into one module by applying the multiple WSS connecting to a plurality of elements E will be described. In other words, both the comparative example and the present embodiment have the same number of the elements E and the same number of input/output ports of each element E called “1×A WSS”, the difference lies in whether one module accommodates one element E (comparative example) or whether a plurality of the elements E are accommodated by multiple-connecting (the present embodiment). In other words, the present embodiment is characterized in that the multiple WSS is applied to each transponder accommodation function portion of each degree to reduce the number of the WSS modules.

FIG. 4 is an explanatory view illustrating principle of the multiple WSS. FIG. 4 illustrates a four-connection configuration of “1×3 WSS”.

The WSS includes input ports Pi[1, 1] to Pi[1, 4], output ports Po[1, 1] to Pi[3, 4], a Planar Lightwave Circuit (PLC) 10, and spatial optical system 20. The input port Pi[i, j] indicates j-series multiple-connecting of the i-th input port. The output port Po[i, j] indicates j-series multiple-connecting of the i-th output port. The spatial optical system 20 is constituted with a lens 21 and a Liquid Crystal on Silicon (LCOS) element 22.

The PLC 10 includes four Spatial Beam Transformers (SBTs) constituted with each including an input/output optical waveguide 11, a slab waveguide 12, and an array waveguide 13. A total of four SBTs are prepared for one input port and three output ports. The constituent elements of the SBT (the input/output optical waveguide 11, the slab waveguide 12, and the array waveguide 13) are known ones described in the optical signal processing apparatus disclosed in JP 2017-219695 A and the optical signal processing apparatus disclosed in JP 2016-212128 A.

The optical signal input from each of the input ports Pi[1, 1] to Pi[1, 4] to the SBT[1] in the PLC 10 is emitted from the array waveguide 13 at a different angle for each j-series. The emitted optical signal is collected and reflected at different positions (WSS[1] to WSS[4]) of the LCOS element 22 that is a spatial light modulator via the lens 21, and is output to each of the output ports Po[1, 1] to Pi[3, 4] via SBT[2] to SBT[4]. That is, each optical signal can be regarded as input/output of an independent optical system.

Accordingly, the SBTs for the input/output ports of the WSS (one input +three outputs =four in total) are prepared, and the PLC 10 including the SBTs and the spatial optical system 20 can be shared by a plurality of j-series. That is, it can be expected that the initial introduction cost is suppressed, the power consumption is reduced, and the load on the control system is reduced as compared with the comparative example in which j modules are individually prepared.

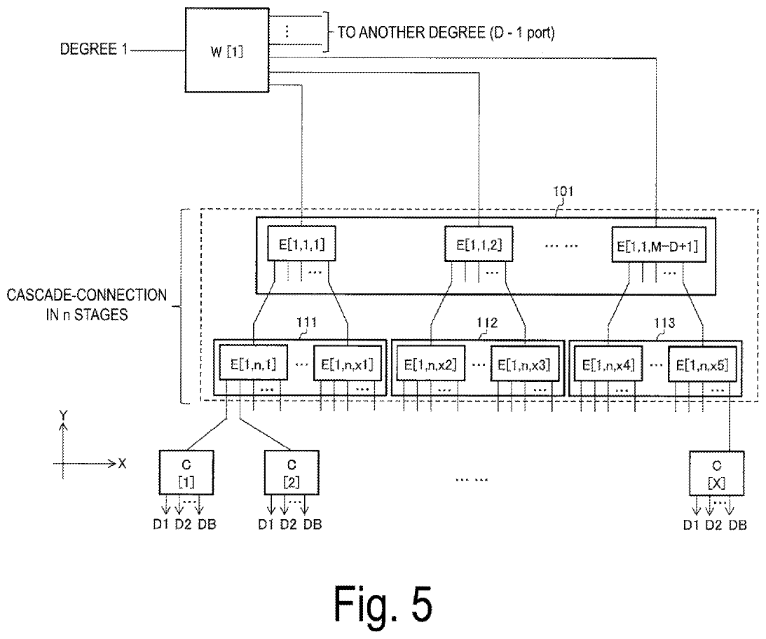

FIG. 5 is a first example in which the principle of the multiple WSS of FIG. 4 is applied to the ROADM of FIG. 2. In FIG. 5, with respect to the group of the elements E cascade-connected in n stages, the multiple WSS is applied to a plurality of WSSs positioned in the same stage with cascade connection, to which an optical signal is propagated from the same degree of the wavelength cross-connect portion, and thus one module implementation is achieved. In FIG. 5, a set of the elements E that are made into one module by applying the multiple WSS is surrounded by rectangles 101 and 111 to 113.
In the first stage of the cascade, a total of the M−D+1 elements E[1, 1, 1], E[1, 1, 2], . . . E[1, 1, M−D+1] are aggregated into one multiple WSS 101.
The n-th stage (final stage) of the cascade is the element E[1, n, 1] to the element E[1, n, x1] branched from the first output port of the w[1] and aggregated into one multiple WSS 111.

Similarly, elements E[1, n, x2] to E[1, n, x3] branched from the second output port of the w[1] are also aggregated into one separate multiple WSS 112.

Similarly, elements E[1, n, x4] to E[1, n, x5] branched from the (M−D+1)th output port of the w[1] are also aggregated into one separate multiple WSS 113.

That is, the number of the multiple WSS is one in the first cascade stage, and the number of the multiple WSSs per stage is M−D+1 in each of the second to n-th stages of the cascade. The multiple WSS connecting of the elements E is merely an aggregation closed within one degree, and the multiple WSS connecting of the elements E across a plurality of degrees is not performed.

With the configuration of FIG. 5, although the number of the elements E that are the “1×A WSS”s of the transponder accommodation function portion is large, the number of the WSS modules can be reduced by multiple-connecting the plurality of elements E into one module.

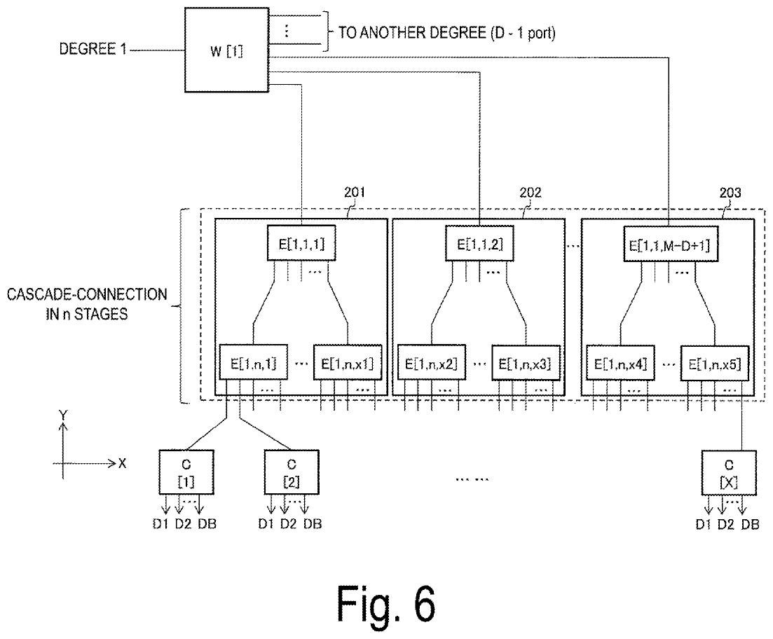

FIG. 6 is a second example in which the principle of the multiple WSS of FIG. 4 is applied to the ROADM of FIG. 2. In FIG. 6, with respect to the group of elements E cascade-connected in n stages, the multiple WSS is applied to the plurality of WSSs to which an optical signal is propagated from the same degree and the same output port (drop port) of the wavelength cross-connect portion, and thus one module implementation is realized. In FIG. 6 as well, a set of elements E that are made into one module by applying the multiple WSS is surrounded by rectangles 201 to 203.
Regardless of the stage number of the cascade, the elements E[1, 1, 1] to E[1, n, 1] to E[1, n, x1] branched from the first output port of the w[1] are aggregated into a first multiple WSS 201.
The elements E[1, 1, 2] to E[1, n, x2] to E[1, n, x3] branched from the second output port of the w[1] are also aggregated into a second multiple WSS 202.
The elements E[1, 1, M−D+1] to E[1, n, x4] to E[1, n, x5] branched from the (M−D+1)th output port of the w[1] are also aggregated into the (M−D+1)th multiple WSS 203.

The multiple WSS connecting of the elements E is merely an aggregation closed within one degree, and the multiple WSS connecting of the elements E across a plurality of degrees is not performed.

The configuration of FIG. 6 can further reduce the number of the WSS modules as compared with the configuration of FIG. 5.

Hereinafter, the configuration of the comparative example to which the multiple WSS is not applied (FIG. 1), the first example of the present embodiment to which the multiple WSS is applied (FIG. 5), and the second example of the present embodiment to which the multiple WSS is applied (FIG. 6) will be compared in detail from the viewpoint of effects.

Hereinafter, the reliability of the module provided in the ROADM, that is, the tolerance of the module to failure will be described. In the configuration of the comparative example (FIG. 1), an independent module is implemented for each degree and for each of the M−D+1 output ports (drop ports) of the wavelength cross-connect portion “1×M WSS”.

First, when a failure occurs in a module connected to a specific degree (for example, a failure of the element E[1, 2, 3]), the influence of the module failure can be avoided by setting such that an optical signal can pass through a detour path using another degree (for example, the element E[2, 2, 3] is used as a substitute).

Additionally, when a failure occurs in a module connected to a specific drop port (for example, a failure of the element E[1, 1, 1]), the influence of the module failure can be avoided by setting such that an optical signal can pass through a detour path using another drop port (for example, the element E[1, 1, 2] is used as a substitute).

The above is the effect on the reliability of the module in the configuration of the comparative example (FIG. 1).

On the other hand, in the first example (FIG. 5) and the second example (FIG. 6) of the present embodiment, the number of the WSS modules can be reduced without impairing (maintaining) the reliability of the module in the comparative example.

First, when a failure occurs in the module connected to a specific degree, the detour path using another degree can be set in the same manner as in the comparative example in both the first example and the second example of the present embodiment.

Additionally, when a failure occurs in the module connected to a specific drop port, in the second example of the present embodiment, a detour path using another degree can be set similarly to the comparative example.

Next, the signal deterioration of an optical signal flowing into the ROADM will be described. In general, increasing the integration of the multiple WSS reduces the number of modules. However, as a side effect of the increase, crosstalk between WSSs occurs between a plurality of optical signals of the same wavelength that pass through the SBT and the LCOS element 22 that are shared components, and the crosstalk is the main factor that deteriorates the signal characteristics.

However, in both the first example and second example of the present embodiment, in the M−D+1 output ports connected from the wavelength cross-connect portion “1×M WSS” of each degree to the transponder accommodation function portion, there is no case where optical signals of the same wavelength are simultaneously input for the plurality of output ports.

As a result, it is possible to avoid the influence of signal deterioration due to the crosstalk between WSSs that is a problem when the multiple WSS is applied.

In the present embodiment, as the configuration of the ROADM (optical cross-connect apparatus) according to the present disclosure, as illustrated in FIG. 1, although the number of degrees is D, the elements E are cascade-connected in n stages, and the number of the output ports of the element E is A, it is not limited to the number and the configuration.

### REFERENCE SIGNS LIST

10 PLC

11 Input/output optical waveguide

12 Slab waveguide

13 Array waveguide

20 Spatial optical system

21 Lens

22 LCOS element

1-4. (canceled)

5. An optical cross-connect apparatus comprising:
a wavelength cross-connect portion connected to a plurality of degrees; and
a transponder accommodation function portion configured to relay an optical signal of the wavelength cross-connect portion to a transponder, wherein
the transponder accommodation function portion is configured such that a plurality of wavelength selective switches including one input port receiving an optical signal from a direction of the wavelength cross-connect portion and a plurality of output ports transmitting an optical signal in a direction toward the transponder is cascade-connected in a plurality of stages.

6. The optical cross-connect apparatus of claim 5, wherein
the plurality of wavelength selective switches positioned at an identical stage of the plurality of stages of cascade connection, to which an optical signal is propagated from a degree of the plurality of degrees of the wavelength cross-connect portion, are multiple-connected as one module.

7. The optical cross-connect apparatus of claim 5, wherein
the plurality of wavelength selective switches to which an optical signal is propagated from a degree of the plurality of degrees and an output port of the wavelength cross-connect portion, are multiple-connected as one module.

8. The optical cross-connect apparatus of claim 5, wherein
the plurality of wavelength selective switches positioned at an identical stage of the plurality of stages of cascade connection, which propagate an optical signal to a degree of the plurality of degrees of the wavelength cross-connect portion, are multiple-connected as one module.

9. The optical cross-connect apparatus of claim 5, wherein
the plurality of wavelength selective switches which propagate an optical signal to a degree of the plurality of degrees and an input port of the wavelength cross-connect portion, are multiple-connected as one module.
